(19) United States
(12) Patent Application Publication
(10) Pub. No.: US 2010/0125801 A1
(43) Pub. Date: May 20, 2010

(54) TERMINAL AND CONTROLLING METHOD THEREOF

(76) Inventor: Sung Min SHIN, Seoul (KR)

Correspondence Address: BIRCH STEWART KOLASCH & BIRCH, PO BOX 747, FALLS CHURCH, VA, 22040-0747, US

(21) Appl. No.: 12/465,409

(22) Filed: May 13, 2009

(30) Foreign Application Priority Data
Nov. 14, 2008 (KR) 10-2008-0113273

(51) Int. Cl. G06F 3/01; G06F 15/16; G06F 3/048

(52) U.S. Cl. 715/758; 715/781; 715/777; 709/206

(57) ABSTRACT

A terminal and controlling method thereof are disclosed, by which a chatting window of a chatting counterpart having sent a chatting content can be automatically activated if the chatting content is received in the course of having a chat with a plurality of counterparts individually. The present invention includes a display module configured to display a messenger for performing chatting with at least one or more chatting counterparts, a wireless communication unit configured to transmit a user-written message to the chatting counterparts, the wireless communication unit configured to receive messages from the chatting counterparts, and a controller configured to individually display chatting windows with the chatting counterparts on a screen of the messenger, if the message is received from a first chatting counterpart among the chatting counterparts, the controller configured to display the received message by activating the corresponding chatting window for performing the chatting with the first chatting counterpart.

### CROSS REFERENCE TO RELATED APPLICATIONS

This application claims the benefit of the Korean Patent Application No. 10-2008-0113273, filed on Nov. 14, 2008, which is hereby incorporated by reference as if fully set forth herein.

### BACKGROUND OF THE INVENTION

1. Field of the Invention

The present invention relates to a terminal and controlling method thereof, and more particularly, to a terminal having a messenger and controlling method thereof. Although the present invention is suitable for a wide scope of applications, it is particularly suitable for a messenger enabling a user to have a chat with other users.

2. Discussion of the Related Art

A mobile terminal is a device which may be configured to perform various functions. Examples of such functions include data and voice communications, capturing images and video via a camera, recording audio, playing music files and outputting music via a speaker system, and displaying images and video on a display. Some terminals include additional functionality which supports game playing, while other terminals are also configured as multimedia players. More recently, mobile terminals have been configured to receive broadcast and multicast signals which permit viewing of contents, such as videos and television programs.

Generally, terminals can be classified into mobile terminals and stationary terminals according to a presence or non-presence of mobility. And, the mobile terminals can be further classified into handheld terminals and vehicle mount terminals according to availability for hand-carry,

There are ongoing efforts to support and increase the functionality of mobile terminals. Such efforts include software and hardware improvements, as well as changes and improvements in the structural components which form the mobile terminal.

Recently, the user's demand for providing a terminal with an instant messenger supported by PC enables the terminal to support the instant messenger.

However, when a user has a chat with a plurality of other users using a related art instant messenger, it is inconvenient for the user to change a chatting window each time to check or write chatting contents.

### SUMMARY OF THE INVENTION

Accordingly, the present invention is directed to a terminal and controlling method thereof that substantially obviate one or more problems due to limitations and disadvantages of the related art.

An object of the present invention is to provide a terminal and controlling method thereof, by which a chatting window of a chatting counterpart having sent a chatting content can be automatically activated if the chatting content is received in the course of having a chat with a plurality of counterparts individually.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a terminal according to the present invention includes a display module configured to display a messenger for performing chatting with at least one or more chatting counterparts, a wireless communication unit configured to transmit a user-written message to the chatting counterparts, the wireless communication unit configured to receive messages from the chatting counterparts, and a controller configured to individually display chatting windows with the chatting counterparts on a screen of the messenger, if the message is received from a first chatting counterpart among the chatting counterparts, the controller configured to display the received message by activating the corresponding chatting window for performing the chatting with the first chatting counterpart.

Preferably, the controller partitions the messenger screen into a plurality of regions and displays the chatting windows of the chatting counterparts on the areas, respectively.

Preferably, the controller displays tab windows including the chatting windows of the chatting counterparts and tables related to the chatting windows on the messenger screen, respectively.

Preferably, the controller deactivates the tab windows of the rest of the chatting counterparts except the first chatting counterpart.

Preferably, the controller displays the activated chatting window of the first chatting counterpart and the deactivated chatting windows of the rest of the chatting counterparts in a manner of discriminating the activated chatting windows from the deactivated chatting windows.

Preferably, if the message is received from the second chatting counterpart while a chatting content is not inputted by the user, the controller activates the chatting window of the second chatting counterpart.

Preferably, if the message is received from the second chatting counterpart while a chatting content is being inputted by the user, the controller activates the chatting window of the second chatting counterpart after completion of an input of the chatting content.

Preferably, if at least one message is received from the second chatting counterpart while a chatting content is being inputted by the user, the controller displays information indicating a reception event of the message and a reception count of the message on the chatting window of the second chatting counterpart before completion of an input of the chatting content. If the input of the chatting content is completed, the controller activates the chatting window of the second chatting counterpart.

Preferably, the controller obtains a message transceiving count of each of the chatting counterparts and then individually displays information indicating the message transceiving count on the chatting window of each of the chatting counterparts.

Preferably, if at least one of the chatting counterparts is selected by the user having completed an input of a chatting content, the controller sends a message including the inputted chatting content to the selected chatting counterparts.

In another aspect of the present invention, a method of controlling a terminal includes the steps of displaying a messenger for performing chatting with at least one or more chatting counterparts and chatting windows with the chatting counterparts on a screen of the messenger individually, if a message is received from a first chatting counterpart among the at least one or more chatting counterparts, activating the corresponding chatting window for performing the chatting with the first chatting counterpart, and displaying the received message on the activated chatting window of the first chatting counterpart.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a terminal according to one embodiment of the present invention;

FIG. 2A is a front perspective diagram of a terminal according to one embodiment of the present invention;

FIG. 2B is a rear perspective diagram of the terminal shown in FIG. 2A;

FIG. 3A and FIG. 3B are front diagrams of a terminal according to one embodiment of the present invention for explaining one operational status of the mobile terminal, respectively;

FIG. 4 is a diagram to explain the concept of proximity depth of a proximity sensor;

FIG. 5 is a diagram to explain the concept of a method of controlling a touch action on a pair of display units 155 and 156 overlapped with each other;

FIG. 6A and FIG. 6B are diagrams to explain the concepts of a proximity touch recognizing area and a haptic area, respectively;

FIG. 7 is a flowchart of a process for performing chatting with a plurality of chatting counterparts on a messenger screen in a terminal according to the present invention;

FIG. 8 is a diagram of screen configuration for displaying chatting windows of a plurality of chatting counterparts on a messenger screen individually according to one embodiment of the present invention;

FIG. 9 is a diagram of screen configuration of a process for switching chatting windows of a plurality of chatting counterparts according to a first embodiment of the present invention;

FIG. 10 is a diagram of screen configuration of a process for switching chatting windows of a plurality of chatting counterparts according to a second embodiment of the present invention;

FIG. 11 is a diagram of screen configuration of a process for switching chatting windows of a plurality of chatting counterparts according to a third embodiment of the present invention;

FIG. 12 is a diagram of screen configuration of a process for switching chatting windows of a plurality of chatting counterparts according to a fourth embodiment of the present invention;

FIG. 13 is a diagram of screen configuration of a process for switching chatting windows of a plurality of chatting counterparts according to a fifth embodiment of the present invention;

FIG. 14 is a diagram of screen configuration of a process for switching chatting windows of a plurality of chatting counterparts according to a sixth embodiment of the present invention; and

FIG. 15 is a diagram of screen configuration of a process for switching chatting windows of a plurality of chatting counterparts according to a seventh embodiment of the present invention.

### DETAILED DESCRIPTION OF THE INVENTION

Reference will now be made in detail to the preferred embodiments of the present invention, examples of which are illustrated in the accompanying drawings. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or like parts.

As used herein, the suffixes ‘module’, ‘unit’ and ‘part’ are used for elements in order to facilitate the disclosure only. Therefore, significant meanings or roles are not given to the suffixes themselves and it is understood that the ‘module’, ‘unit’ and ‘part’ can be used together or interchangeably.

The present invention can be applicable to a various types of terminals. Examples of such terminals include mobile as well as stationary terminals, such as mobile phones, user equipment, smart phones, DTV, computers, digital broadcast terminals, personal digital assistants, portable multimedia players (PMP) and navigators.

However, by way of non-limiting example only, further description will be with regard to a mobile terminal 100, and it should be noted that such teachings may apply equally to other types of terminals.

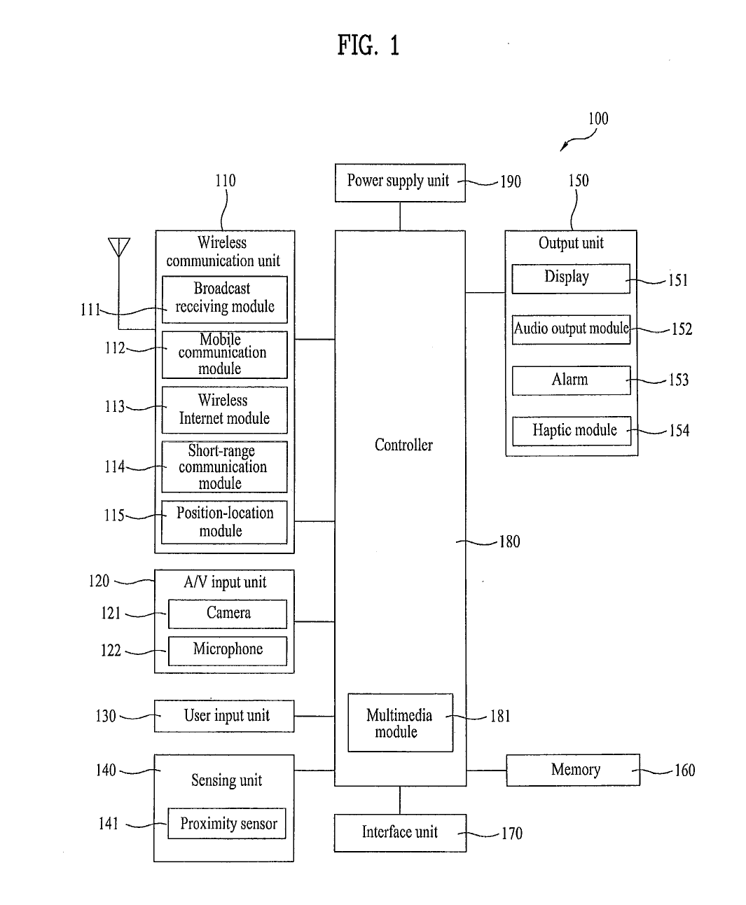

FIG. 1 is a block diagram of a mobile terminal 100 in accordance with an embodiment of the present invention. FIG. 1 shows the mobile terminal 100 having various components, but it is understood that implementing all of the illustrated components is not a requirement. Greater or fewer components may alternatively be implemented.

FIG. 1 shows a wireless communication unit 110 configured with several commonly implemented components. For example, the wireless communication unit 110 typically includes one or more components which permit wireless communication between the mobile terminal 100 and a wireless communication system or network within which the mobile terminal is located. In case of non-mobile terminals, the wireless communication unit 110 can be replaced with a wire communication unit. The wireless communication unit 110 and wire communication unit can be commonly referred to as a communication unit. A broadcast receiving module Ill receives a broadcast signal and/or broadcast associated information from an external broadcast managing entity via a broadcast channel. The broadcast channel may include a satellite channel and a terrestrial channel. The broadcast managing entity generally refers to a system which transmits a broadcast signal and/or broadcast associated information.

Examples of broadcast associated information include information associated with a broadcast channel, a broadcast program, a broadcast service provider, etc. For example, the broadcast associated information may include an electronic program guide (EPG) of digital multimedia broadcasting (DMB) and an electronic service guide (ESG) of digital video broadcast-handheld (DVB-H).

The broadcast signal may be implemented, for example, as a TV broadcast signal, a radio broadcast signal, and a data broadcast signal. If desired, the broadcast signal may further include a broadcast signal combined with a TV or radio broadcast signal.

The broadcast receiving module 111 may be configured to receive broadcast signals transmitted from various types of broadcast systems. By nonlimiting example, such broadcasting systems include digital multimedia broadcasting-terrestrial (DMB-T), digital multimedia broadcasting-satellite (DMB-S), digital video broadcast-handheld (DVB-H), the data broadcasting system known as media forward link only (MediaFLO®) and integrated services digital broadcast-terrestrial (ISDB-T). Receiving multicast signals is also possible. If desired, data received by the broadcast receiving module 111 may be stored in a suitable device, such as a memory 160.

A mobile communication module 112 communicates wireless signals with one or more network entities such as a base station or Node-B. Such signals may represent, for example, audio, video, multimedia, control signaling, and data.

In this case, the mobile communication module 112 transmits/receives video communication signals with other terminals via a video communication channel according to the video communication protocol by H.223, H.245, H.324M or the like. In doing so, the video communication signal contains video, video communication voice and video chatting characters.

A wireless internet module 113 supports Internet access for the mobile terminal 100. This module may be internally or externally coupled to the mobile terminal 100. Suitable technologies for wireless internet may include, but are not limited to, WLAN (Wireless LAN)(Wi-Fi), Wibro (Wireless broadband), Wimax (World Interoperability for Microwave Access), and HSDPA(High Speed Downlink Packet Access). The wireless internet module can be replaced with a wire internet module in non-mobile terminals. The wireless internet module 113 and wire internet module may be commonly referred to as an internet module.

A short-range communication module 114 facilitates relatively short-range communications. Suitable technologies for short-range communication my include, but are not limited to, radio frequency identification (RFID), infrared data association (IrDA), ultra-wideband (UWB), as well as the networking technologies commonly referred to as Bluetooth and ZigBee.

A position-location module 115 identifies or otherwise obtains the location of the mobile terminal 100. This module may be implemented using, for example, global positioning system (GPS) components which cooperate with associated satellites, network components, and combinations thereof.

According to the current technology, the GPS module 115 is able to precisely calculate current 3-dimensional position information based on longitude, latitude and altitude by calculating distance information and precise time information from at least three satellites and then applying triangulation to the calculated information. Currently, location and time informations are calculated using three satellites, and errors of the calculated location position and time informations are then amended using another satellite. Besides, the GPS module 115 is able to calculate speed information by continuously calculating a real-time current location.

An audio/video (A/V) input unit 120 is configured to provide audio or video signal input to the mobile terminal 100. As shown, the A/V input unit 120 includes a camera 121 and a microphone 122. The camera 121 receives and processes image frames of still pictures or video.

A microphone 122 receives an external audio signal while the portable device is in a particular mode, such as phone call mode, recording mode or voice recognition mode. This audio signal is processed and converted into digital data.

The portable device, and specifically the A/V input unit 120, typically includes assorted noise removing algorithms to remove noise generated in the course of receiving the external audio signal. Data generated by the A/V input unit 120 may be stored in the memory 160, utilized by the output unit 150, or transmitted via one or more modules of communication unit 110. If desired, two or more microphones and/or cameras may be used.

A user input unit 130 generates input data responsive to user manipulation of an associated input device or devices. Examples of such devices include a keypad, a dome switch, a touchpad such as static pressure/capacitance, a jog wheel and a jog switch. A specific example is one in which the user input unit 130 is configured as a touchpad in cooperation with a display, which will be described in more detail below.

A sensing unit 140 provides status measurements of various aspects of the mobile terminal 100. For example, the sensing unit may detect an open/close status of the mobile terminal 100, relative positioning of components such as a display and keypad of the mobile terminal, a change of position of the mobile terminal or a component of the mobile terminal, a presence or absence of user contact with the mobile terminal, orientation or acceleration/deceleration of the mobile terminal.

If the mobile terminal 100 is configured as a slide-type mobile terminal, the sensing unit 140 may sense whether a sliding portion of the mobile terminal is open or closed.

Meanwhile, the output unit 150 is provided to generate an output relevant to a sight sense, an auditory sense, a tactile sense or the like. And, the output unit 150 can include a display unit 151, an audio output module 152, an alarm unit 153, a haptic module 154 and the like.

The display unit 151 displays (outputs) information processed by the terminal 100. For instance, in case that the terminal is in a call mode, the display unit 151 displays a user interface (UI) or a graphic user interface (GUI) associated with the call. In case that the terminal 100 is in a video communication mode or a photograph mode, the display unit 151 displays a photographed and/or received picture, a UI or a GUI.

The display unit 151 can include at least one selected from the group consisting of a liquid crystal display (LCD), a thin film transistor liquid crystal display (TFT LCD), an organic light-emitting diode (OLED), a flexible display, and a 3-dimensional display.

Some of them can have a transparent or light-transmittive type configuration to enable an external environment to be seen through. This can be called a transparent display. As a representative example for the transparent display, there is a transparent OLED (TOLED) or the like. A backside structure of the display unit 151 can have the light-transmittive type configuration as well. Owing to this configuration, a user is able to see an object located behind the terminal body through the area occupied by the display unit 151 of the terminal body.

According to implementation of the terminal 100, at least two display units 151 can be provided. For instance, a plurality of display units can be provided to a single face of the terminal 100 by being built in one body or spaced apart from the single face. Alternatively, a plurality of the display units can be provided to different faces of the terminal 100, respectively.

In case that the display unit 151 and a sensor for detecting a touch action (hereinafter named a touch sensor) construct a mutual-layered structure (hereinafter named a touchscreen), the display unit 151 can be used as an input device as well as an output device. For instance, the touch sensor can include a touch film, a touch sheet, a touchpad or the like.

The touch sensor can be configured to convert a pressure applied to a specific portion of the display unit 151 or a variation of electrostatic capacity generated from a specific portion of the display unit 151 to an electric input signal. The touch sensor can be configured to detect a pressure of a touch as well as a position and size of the touch.

If a touch input is provided to the touch sensor, signal(s) corresponding to the touch input is transferred to a touch controller. The touch controller processes the signal(s) and then transfers corresponding data to the controller 180. Therefore, the controller 180 is able to know which portion of the display unit 151 is touched and the like.

Referring to FIG. 1, the proximity sensor 141 can be provided within the mobile terminal enclosed by the touchscreen or around the touchscreen. The proximity sensor 141 is the sensor that detects a presence or non-presence of an object approaching a prescribed detecting surface or an object existing around the sensor using an electromagnetic field strength or infrared ray without mechanical contact. The proximity sensor has durability longer than that of the contact type sensor and also has usages wider than those of the contact type sensor.

The proximity sensor can include one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor and the like. In case that the touchscreen is an electrostatic type, the proximity sensor is configured to detect proximity of a pointer using a variation of an electric field according to the proximity of the pointer. In this case, the touchscreen (touch sensor) can be classified into the proximity sensor.

In the following description, for clarity, an action that a pointer approaches without contacting with the touchscreen to be recognized as located on the touchscreen is named ‘proximity touch’. And, an action that a pointer actually touches the touchscreen is named ‘contact touch’. The meaning of the location of the touchscreen proximity-touched by the pointer means the position of the pointer which vertically opposes the touchscreen when the pointer performs the proximity touch.

The proximity sensor detects a proximity touch and a proximity touch pattern (e.g., a proximity touch distance, a proximity touch duration, a proximity touch position, a proximity touch shift state, etc.). And, information corresponding to the detected proximity touch action and the detected proximity touch pattern can be outputted to the touchscreen.

The audio output module 152 is able to output audio data that is received from the wireless communication unit 110 in a call signal reception mode, a call mode, a recording mode, a voice recognition mode, a broadcast receiving mode or the like. The audio output module 152 is able to output audio data stored in the memory 160. The audio output module 152 is able to output an audio signal relevant to a function (e.g., a call signal receiving sound, a message receiving sound, etc.) performed by the terminal 100. And, the audio output module 152 can include a receiver, a speaker, a buzzer or the like.

The alarm unit 153 outputs a signal for announcing an event occurrence of the terminal 100. An event occurring in the terminal 100 can include one of a call signal reception, a message reception, a key signal input, a touch input and the like. The alarm unit 153 is able to output a signal for announcing an event occurrence by ways of vibration or the like as well as a video signal or an audio signal. The video signal can be outputted via the display unit 151. And, the audio signal can be outputted via the audio output module 152. Hence, the display unit 151 or the audio output module 152 can be classified into a part of the alarm unit 153.

The haptic module 154 brings about various haptic effects that can be sensed by a user. And, vibration is the representative example for the haptic effect brought about by the haptic module 154. Strength and pattern of the vibration generated from the haptic module 154 are controllable. For instance, vibrations differing from each other are outputted in a manner of being synthesized together or can be sequentially outputted.

The haptic module 154 is able to generate various haptic effects including a vibration, an effect caused by such a stimulus as a pin array vertically moving against a contact skin surface, a jet power of air via outlet, a suction power of air via inlet, a skim on a skin surface, a contact of electrode, an electrostatic power and the like, and an effect by hot/cold sense reproduction using an endothermic or exothermic device as well as the vibration.

The haptic module 154 is able to carry the haptic effect via direct contact. And, the haptic module 154 can be implemented to enable a user to experience the haptic effect via muscular sense of finger, arm or the like. Moreover, at least two haptic modules 154 can be provided according to the configuration type of the mobile terminal 100.

The memory 160 can store a program for operations of the controller 180. The memory 160 is able to temporarily store input/output data (e.g., phonebook, message, still picture, moving picture, etc.). And, the memory 160 is able to store data of vibration and sound in various patterns outputted in case of a touch input to the touchscreen.

The memory 160 can include at least one of a flash memory, a hard disk, a multimedia card micro type memory, a card type memory (e.g., SD memory, XD memory, etc.), a random access memory (RAM), a static random access memory (SRAM), a read-only memory (ROM), an electrically erasable programmable read-only memory, a programmable read-only memory, a magnetic memory, a magnetic disk, an optical disk, and the like. The terminal 100 is able to operate in association with a web storage that performs a storage function of the memory 160 in Internet.

Moreover, the memory 160 can includes the instant messenger software for performing an instant message service for chatting with at least one or more counterparts.

The instant messenger software enables the instant message service using a message service on a mobile communication network. In particular, the instant messenger software enables a message to be sent to at least one or more chatting counterparts using a message service protocol like the related art PC-based instant messenger service.

The instant messenger software is capable of broadcasting a message to at least one or more chatting counterparts like the conventional PC-based instant messenger. Moreover, the instant messenger software enables the at least one or more chatting counterparts to broadcast response messages to other chatting counterparts.

In case that a user selects at least one or more chatting counterparts, the instant messenger software stores addresses on the chatting counterparts. Hence, once the addresses are stored, the instant messenger software removes the inconvenience for inputting addresses of chatting counterparts one by one in transmitting/receiving messages in the future.

Besides, the instant messenger software is able to send information on the chatting counterparts together with or separate from a message to send.

Therefore, as mentioned in the above description, each of the chatting counterparts is able to receive the information on the rest of the chatting counterparts and is then able to broadcast response message to the user and the rest of the chatting counterparts using the received information.

Thus, the instant messenger software can be run under the control of the controller 180 in a manner of being stored as a program in the memory 160 or being provided as a module.

The interface unit 170 plays a role as a passage to all external devices connected to the terminal 100. The interface unit 170 receives data from an external device. The interface unit 170 is supplied with a power and then delivers it to each element within the terminal 100. And, the interface unit 170 enables data to be transferred to an external device from an inside of the terminal 100. And, the interface unit 170 can include a wire/wireless headset port, an external charger port, a wire/wireless data port, a memory card port, a port for coupling to a device having an identity module, an audio input/output (I/O) port, a video input/output (I/O) port, an earphone port and the like.

The identity module is the chip that stores various kinds of information for authenticating use authority of the terminal 100. And, the identify module can include a user identity module (UIM), a subscriber identity module (SIM), a universal subscriber identity module (USIM) or the like. A device provided with the above identity module, which is named an identity device hereinafter, can be manufactured in a smart card form. Hence, the identity device can be connected to the terminal 100 via the port.

The interface unit 170 can play a role as a passage for supplying a power to the terminal 100 from a cradle that is connected to the terminal 100. And, the interface unit 170 is able to play a role as a passage for delivering various command signals, which are inputted from the cradle by a user, to the terminal 100. Various command signals inputted from the cradle or the power can work as a signal for recognizing that the mobile terminal is correctly loaded in the cradle.

The controller 180 controls overall operations of the terminal in general. For instance, the controller 180 performs control and processing relevant to a voice call, a data communication, a video conference and the like. The controller 180 may have a multimedia module 181 for multimedia playback. The multimedia module 181 can be implemented within the controller 180 or can be configured separate from the controller 180.

And, the controller 180 is able to perform pattern recognizing processing for recognizing a handwriting input performed on the touchscreen as a character or recognizing a picture drawing input performed on the touchscreen as an image.

The power supply unit 190 receives an external or internal power and then supplies the power required for operations of the respective elements under the control of the controller 180.

Various embodiments of the present invention explained in the following description can be implemented within a recording medium that can be read by a computer or a computer-like device using software, hardware or combination thereof.

According to the hardware implementation, the following embodiments can be implemented using at least one of ASICs (application specific integrated circuits), DSPs (digital signal processors), DSPDs (digital signal processing devices), PLDs (programmable logic devices), FPGAs (field programmable gate arrays, processors, controllers, microcontrollers, microprocessors and electrical units for performing other functions. In some cases, the embodiments can be implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory such as the memory 160, and executed by a controller or processor, such as the controller 180.

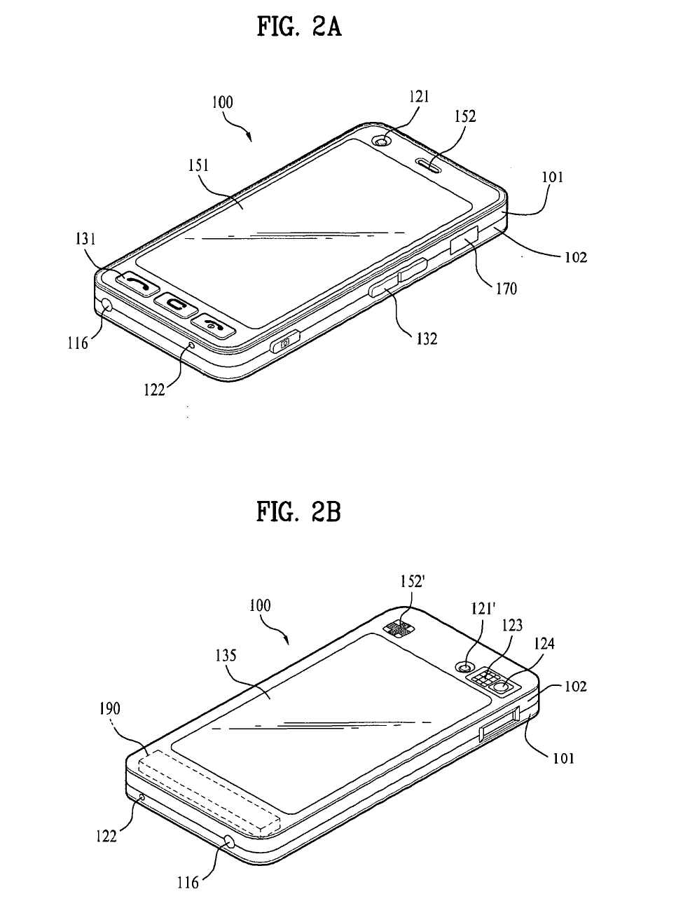

FIG. 2A is a front-view perspective diagram of a terminal according to one embodiment of the present invention.

Referring to FIG. 2A, a terminal 100 includes a bar type terminal body. Yet, by way of non-limiting example, the present invention is able to a terminal that be implemented in a variety of different configurations. Examples of such configurations include folder-type, slide-type, bar-type, rotational-type, swing-type and combinations thereof.

The body includes a case (casing, housing, cover, etc.) that forms an exterior of the terminal. In the present invention, the case can be divided into a front case 101 and a rear case 102. Various electric/electronic parts are loaded in a space provided between the front and rear cases 101 and 102. Optionally, at least one middle case can be further provided between the front and rear cases 101 and 102 in addition.

The cases are formed by injection molding of synthetic resin or can be formed of metal substance such as stainless steel (STS), titanium (Ti) or the like for example.

A display unit 151, an audio output unit 152, a camera 121, user input units 130/131 and 132, a microphone 122, an interface 180 and the like can be provided to the terminal body, and more particularly, to the front case 101.

The display unit 151 occupies most of a main face of the front case 101. The audio output unit 151 and the camera 121 are provided to an area adjacent to one of both end portion of the display unit 151, while the user input unit 131 and the microphone 122 are provided to another area adjacent to the other end portion of the display unit 151. The user input unit 132 and the interface 170 can be provided to lateral sides of the front and rear cases 101 and 102.

The input unit 130 is manipulated to receive a command for controlling an operation of the terminal 100. And, the input unit 130 is able to include a plurality of manipulating units 131 and 132. The manipulating units 131 and 132 can be named a manipulating portion and may adopt any mechanism of a tactile manner that enables a user to perform a manipulation action by experiencing a tactile feeling.

Content inputted by the first or second manipulating unit 131 or 132 can be diversely set. For instance, such a command as start, end, scroll and the like is inputted to the first manipulating unit 131. And, a command for a volume adjustment of sound outputted from the audio output unit 152, a command for a switching to a touch recognizing mode of the display unit 151 or the like can be inputted to the second manipulating unit 132.

FIG. 2B is a perspective diagram of a backside of the terminal shown in FIG. 2A.

Referring to FIG. 2B, a camera 121′ can be additionally provided to a backside of the terminal body, and more particularly, to the rear case 102. The camera 121 has a photographing direction that is substantially opposite to that of the former camera 121 shown in FIG. 21A and may have pixels differing from those of the firmer camera 121.

Preferably, for instance, the former camera 121 has low pixels enough to capture and transmit a picture of user's face for a video call, while the latter camera 121′ has high pixels for capturing a general subject for photography without transmitting the captured subject. And, each of the cameras 121 and 121′ can be installed at the terminal body to be rotated or popped up.

A flash 123 and a mirror 124 are additionally provided adjacent to the camera 121′. The flash 123 projects light toward a subject in case of photographing the subject using the camera 121′. In case that a user attempts to take a picture of the user (self-photography) using the camera 121′, the mirror 124 enables the user to view user's face reflected by the mirror 124.

An additional audio output unit 152′ can be provided to the backside of the terminal body. The additional audio output unit 152′ is able to implement a stereo function together with the former audio output unit 152 shown in FIG. 2A and may be used for implementation of a speakerphone mode in talking over the terminal.

A broadcast signal receiving antenna 124 can be additionally provided to the lateral side of the terminal body as well as an antenna for communication or the like. The antenna 124 constructing a portion of the broadcast receiving module 111 shown in FIG. 1 can be retractably provided to the terminal body.

A power supply unit 190 for supplying a power to the terminal 100 is provided to the terminal body. And, the power supply unit 190 can be configured to be built within the terminal body. Alternatively, the power supply unit 190 can be configured to be detachably connected to the terminal body.

A touchpad 135 for detecting a touch can be additionally provided to the rear case 102. The touchpad 135 can be configured in a light transmittive type like the display unit 151. In this case, if the display unit 151 is configured to output visual information from its both faces, it is able to recognize the visual information via the touchpad 135 as well. The information outputted from both of the faces can be entirely controlled by the touchpad 135. Alternatively, a display is further provided to the touchpad 135 so that a touchscreen can be provided to the rear case 102 as well.

The touchpad 135 is activated by interconnecting with the display unit 151 of the front case 101. The touchpad 135 can be provided in rear of the display unit 151 in parallel. The touchpad 135 can have a size equal to or smaller than that of the display unit 151.

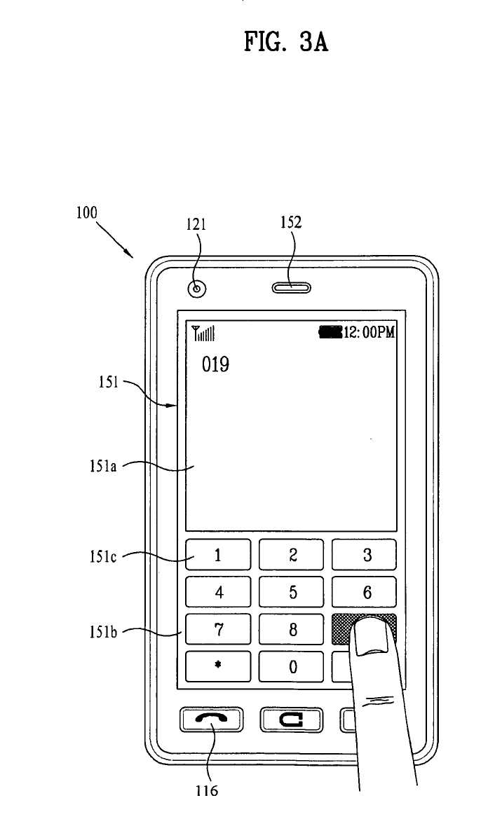

Interconnected operational mechanism between the display unit 151 and the touchpad 135 are explained with reference to FIG. 3A and FIG. 3B as follows.

FIG. 3A and FIG. 3B are front-view diagrams of a terminal according to one embodiment of the present invention for explaining an operational state thereof.

First of all, various kinds of visual informations can be displayed on the display unit 151. And, theses informations can be displayed in characters, numerals, symbols, graphics, icons and the like.

In order to input the information, at least one of the characters, numerals, symbols, graphics and icons are represented as a single predetermined array to be implemented in a keypad formation. And, this keypad formation can be so-called ‘soft keys’.

FIG. 3A shows that a touch applied to a soft key is inputted through a front face of a terminal body.

The display unit 151 is operable through an entire area or by being divided into a plurality of regions. In the latter case, a plurality of the regions can be configured interoperable.

For instance, an output window 151a and an input window 151b are displayed on a top portion and a bottom portion of the display unit 151, respectively. A soft key 151c representing a digit for inputting a phone number or the like is outputted to the input window 151b. If the soft key 151c is touched, a digit corresponding to the touched soft key is outputted to the output window 151a. If the first manipulating unit 131 is manipulated, a call connection for the phone number displayed on the output window 151a is attempted.

FIG. 3B shows that a touch applied to a soft key is inputted through a rear face of a terminal body. If FIG. 3A shows a case that the terminal body is vertically arranged (portrait), FIG. 3B shows a case that the terminal body is horizontally arranged (landscape). And, the display unit 151 can be configured to change an output picture according to the arranged direction of the terminal body.

FIG. 3B shows that a text input mode is activated in the terminal.

An output window 135a and an input window 135b are displayed on the display unit 151. A plurality of soft keys 135c representing at least one of characters, symbols and digits can be arranged in the input window 135b. The soft keys 135c can be arranged in the QWERTY key formation.

If the soft keys 135c are touched through the touchpad 135, the characters, symbols and digits corresponding to the touched soft keys are outputted to the output window 135a. Thus, the touch input via the touchpad 135 is advantageous in that the soft key 135c can be prevented from being blocked by a finger in case of touch, which is compared to the touch input via the display unit 151. In case that the display unit 151 and the touchpad 135 are configured transparent, it is able to visually check fingers located at the backside of the terminal body. Hence, more correct touch inputs are possible.

Besides, the display unit 151 or the touchpad 135 can be configured to receive a touch input by scroll. A user scrolls the display unit 151 or the touchpad 135 to shift a cursor or pointer located at an entity (e.g., icon or the like) displayed on the display unit 151. Furthermore, in case that a finger is shifted on the display unit 151 or the touchpad 135, a path of the shifted finger can be visually displayed on the display unit 151. This may be useful in editing an image displayed on the display unit 151.

To cope with a case that both of the display unit (touchscreen) 151 and the touchpad 135 are touched together within a predetermined time range, one function of the terminal can be executed. The above case of the simultaneous touch may correspond to a case that the terminal body is held by a user using a thumb and a first finger (clamping). The above function can include activation or deactivation for the display unit 151 or the touchpad 135.

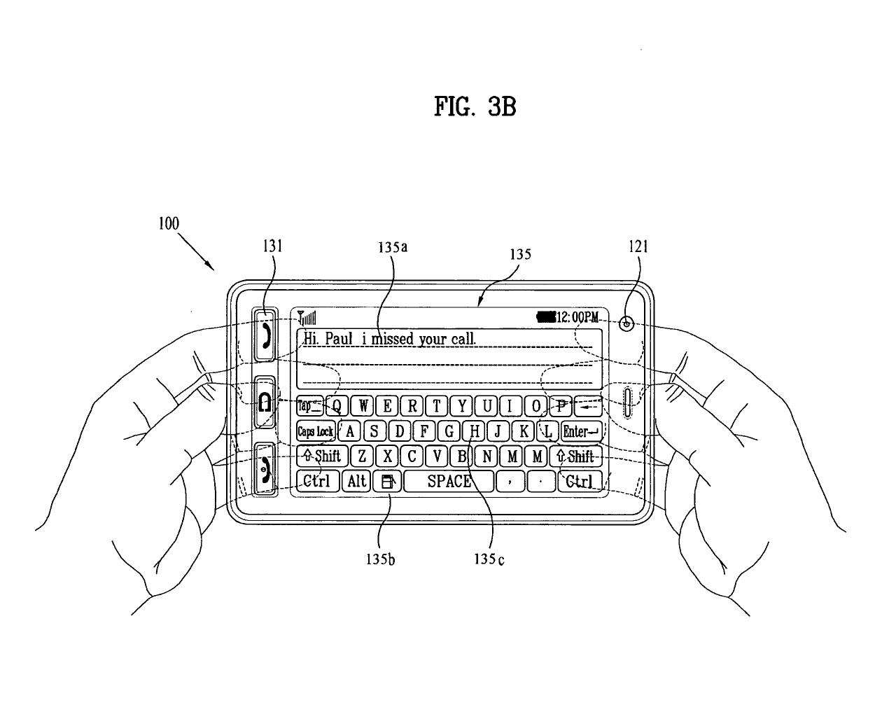

The proximity sensor 141 described with reference to FIG. 1 is explained in detail with reference to FIG. 4 as follows.

FIG. 4 is a conceptional diagram for explaining a proximity depth of a proximity sensor.

Referring to FIG. 4, when such a pointer as a user's finger, a pen and the like approaches the touchscreen, a proximity sensor 141 provided within or in the vicinity of the touchscreen detects the approach of the pointer and then outputs a proximity signal.

The proximity sensor 141 can be configured to output a different proximity signal according to a distance between the pointer and the proximity-touched touchscreen (hereinafter named ‘proximity depth).

In FIG. 4, exemplarily shown is a cross-section of the touchscreen provided with a proximity sensor capable to three proximity depths for example. And, it is understood that a proximity sensor capable of proximity depths amounting to the number smaller than 3 or equal to or greater than 4 is possible.

In detail, in case that the pointer is fully contacted with the touchscreen (d0), it is recognized as a contact touch. In case that the pointer is located to be spaced apart from the touchscreen in a distance smaller than d1, it is recognized as a proximity touch to a first proximity depth. In case that the pointer is located to be spaced apart from the touchscreen in a distance between d1 and d2, it is recognized as a proximity touch to a second proximity depth. In case that the pointer is located to be spaced apart from the touchscreen in a distance smaller than d3 or equal to or greater than d2, it is recognized as a proximity touch to a third proximity depth. In case that the pointer is located to be spaced apart from the touchscreen in a distance equal to or greater than d3, it is recognized as a proximity touch is released.

Hence, the controller 180 is able to recognize the proximity touch as one of various input signals according to the proximity depth and position of the pointer. And, the controller 180 is able to perform various operation controls according to the various input signals.

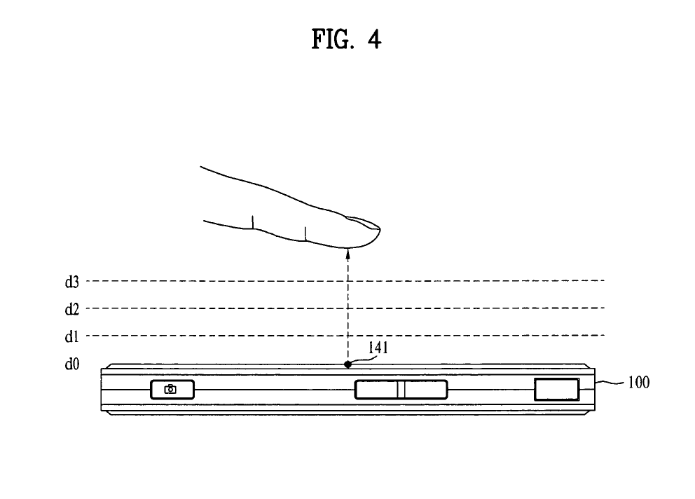

FIG. 5 is a conceptional diagram for exampling a method of controlling a touch action in a state that a pair of display units 155 and 156 are overlapped with each other.

Referring to FIG. 5, a terminal shown in the drawing is a folder type terminal in which a folder part is connected to a main body in a manner of being folded or unfolded.

A first display unit 155 provided to the folder part is a light-transmittive or transparent type such as TOLED, while a second display unit 156 provided to the main body may be a non-transmittive type such as LCD. Each of the first and second display units 155 and 156 can include a touch-inputtable touchscreen.

For instance, if a touch (contact touch or proximity touch) to the first display unit or TOLED 155 is detected, the controller 180 selects or runs at least one image from an image list displayed on the TOLED 155 according to a touch type and a touch duration.

In the following description, a method of controlling information displayed on a different display unit or an LCD 156 in case of an touch to the TOLED 155 externally exposed in an overlapped configuration is explained, in which the description is made with reference to input types classified into a touch, a long touch, a long-touch & drag and the like.

In the overlapped state (a state that mobile terminal is closed or folder), the TOLED 155 is configured to be overlapped with the LCD 156. In this state, if a touch different from a touch for controlling an image displayed on the TOLED 155, e.g., a long touch (e.g., a touch having a duration of at least 2 seconds) is detected, the controller 180 enables at least one image to be selected from an image list displayed on the LCD 156 according to the touched touch input. The result from running the selected image is displayed on the TOLED 155.

The long touch is usable in selectively shifting a specific one of entities displayed on the LCD 156 to the TOLED 155 (without an action for running the corresponding entity). In particular, if a user performs a long touch on a prescribed region of the TOLED 155 corresponding to a specific entity of the LCD 156, the controller 180 controls the corresponding entity to be displayed by being shifted to the TOLED 155.

Meanwhile, an entity displayed on the TOLED 155 can be displayed by being shifted to the LCD 156 according to such a prescribed touch input to the TOLED 155 as flicking, swirling and the like. In the drawing, exemplarily shown is that a second menu displayed on the LCD 156 is displayed by being shifted to the TOLED 155.

In case that another input, e.g., a drag is additionally detected together with a long touch, the controller 180 executes a function associated with an image selected by the long touch so that a preview picture for the image can be displayed on the TOLED 155 for example. In the drawing, exemplarily shown is that a preview (picture of a male) for a second menu (image file) is performed.

While the preview image is outputted, if a drag toward a different image is additionally performed on the ROLED 155 by maintaining the long touch, the controller 180 shifts a selection cursor (or a selection bar) of the LCD 156 and then displays the image selected by the selection cursor on the preview picture (picture of female). Thereafter, after completion of the touch (long touch and drag), the controller 180 displays the initial image selected by the long touch.

The touch action (long touch and drag) is identically applied to a case that a slide (action of a proximity touch corresponding to the drag) is detected to together with a long proximity touch (e.g., a proximity touch maintained for at least 2 or 3 seconds) to the TOLED 155.

In case that a touch action differing from the above-mentioned touch actions is detected, the controller 180 is able to operate in the same manner of the general touch controlling method.

The method of controlling the touch action in the overlapped state is applicable to a terminal having a single display. And, the method of controlling the touch action in the overlapped state is applicable to terminals differing from the folder type terminal having a dual display as well.

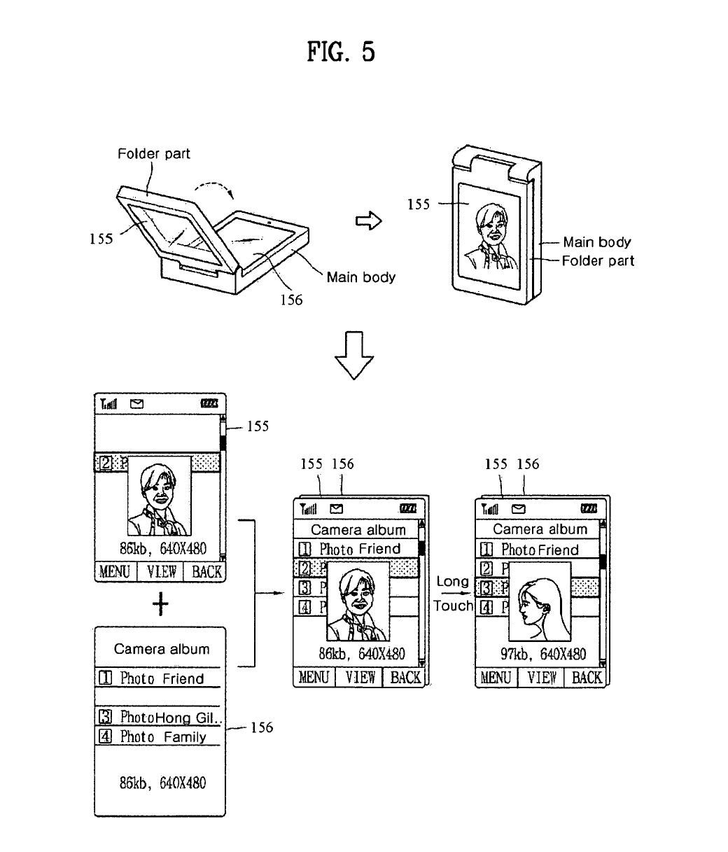

FIG. 6A and FIG. 6B are diagrams for the description of a proximity touch recognition area and a tactile effect generation region.

FIG. 6A represents such an object as an icon, a menu item and the like in a circle type for clarity and convenience of explanation.

A region for displaying an object on the display unit 151, as shown in (a) of FIG. 6A, can be divided into a first region A at a central part and a second region B enclosing the first region A. The first and second regions A and B can be configured to generate tactile effects differing from each other in strength or pattern. For instance, the firs and second regions can be configured to generate 2-step vibrations in a manner of outputting a first vibration if the second region B is touched or outputting a second vibration greater than the first vibration if the first region A is touched.

In case that both of the proximity touch recognition region and the haptic region are simultaneously set in the region having the object displayed therein, it is able to set the haptic region for generating the tactile effect to be different from the proximity touch recognition region for detecting the proximity signal. In particular, it is able to set the haptic region to be narrower or wider than the proximity touch recognition region. For instance, in (a) of FIG. 6A, it is able to set the proximity touch recognition region to the area including both of the first and second regions A and B. And, it is able to set the haptic region to the first region A.

It is able to discriminate the region having the object displayed therein into three regions A, B and C as shown in (b) of FIG. 6A. Alternatively, it is able to discriminate the region having the object displayed therein into N regions (N>4) as shown in (c) of FIG. 6A. And, it is able to configure each of the divided regions to generate a tactile effect having a different strength or pattern. In case that a region having a single object represented therein is divided into at least three regions, it is able to set the haptic region and the proximity touch recognition region to differ from each other according to a use environment.

It is able to configure a size of the proximity touch recognition region of the display unit 151 to vary according to a proximity depth. In particular, referring to (a) of FIG. 6B, the proximity touch recognition region is configured to decrease by C→B→A according to the proximity depth for the display unit 151. On the contrary, the proximity touch recognition region is configured to increase by C→B→A according to the proximity depth for the display unit 151. Despite the above configuration, it is able to set the haptic region to have a predetermined size, as the region ‘H’ shown in (b) of FIG. 6B, regardless of the proximity depth for the display unit 151.

In case of dividing the object-displayed region for the setting of the haptic region or the proximity touch recognition region, it is able to use one of various schemes of horizontal/vertical division, radial division and combinations thereof as well as the concentric circle type division shown in FIG. 6A.

In the following description, embodiments for a chatting control process in the above configured terminal 100 are explained with reference to the accompanying drawings. And, it is understood that the following embodiments can be used singly or by being combined together.

In case that the display module 151 includes the touchscreen, the following embodiments can be implemented more easily.

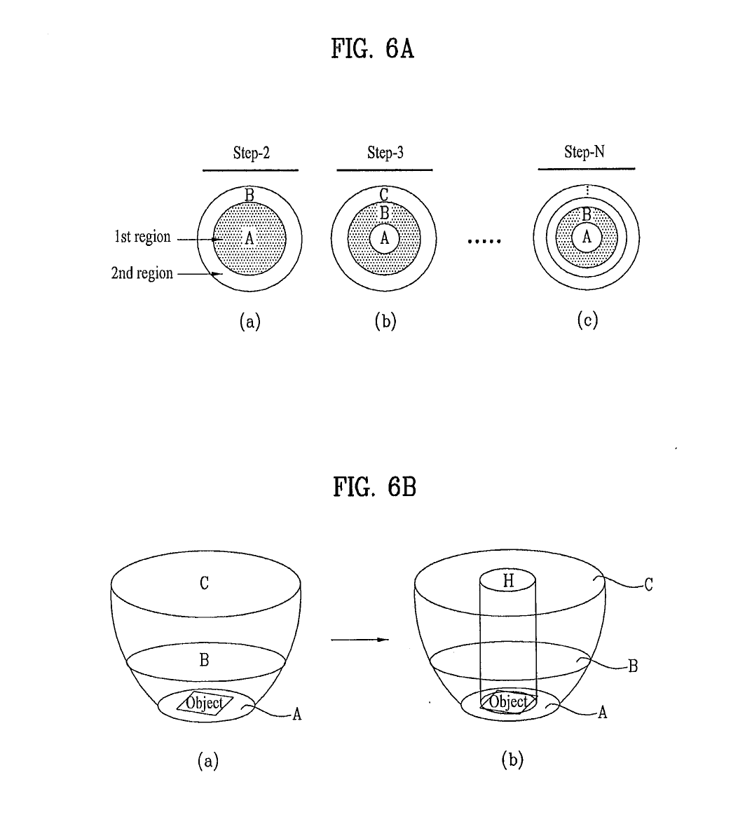

FIG. 7 is a flowchart of a process for performing chatting with a plurality of chatting counterparts on a messenger screen in a terminal according to the present invention.

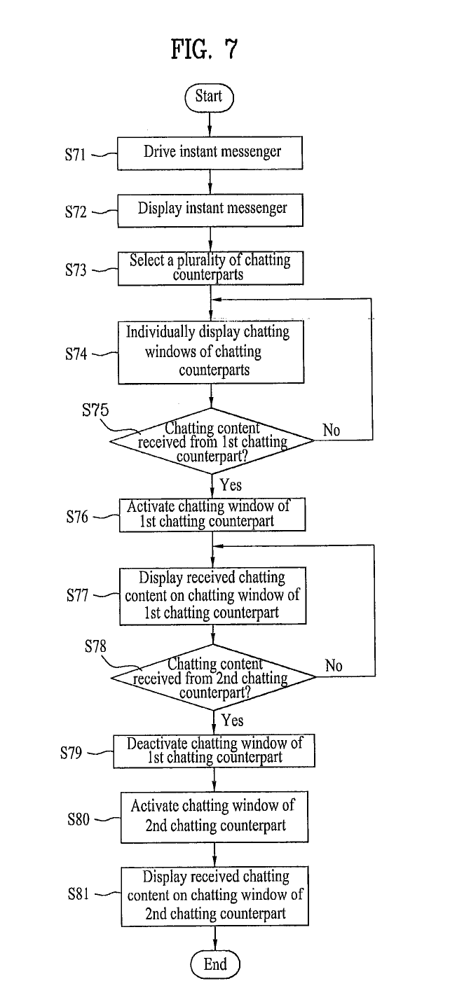

FIG. 8 is a diagram of screen configuration for displaying chatting windows of a plurality of chatting counterparts on a messenger screen individually according to one embodiment of the present invention.

Referring to FIG. 7 and FIG. 8, if a user inputs a command for executing an instant messenger function via the input unit 130 or the touchscreen 151, the controller 180 of the terminal 100 activates an instant messenger by driving the instant messenger software stored in the memory 160 [S71] and displays an instant messenger picture on a screen of the touchscreen 151 [S72].

In doing so, the instant messenger can be configured in a software format or a module format.

If the user selects user-preferred chatting counterparts 20, 30 and 40 from pre-registered chatting counterparts 20, 30, 40 and 50, as shown in (a) of FIG. 8, by manipulating the input unit 130 or the touchscreen 151 [S73], the controller 180 individually displays chatting windows for chatting with the selected chatting counterparts 20, 30 and 40 on the screen of the messenger [S74].

In particular, referring to (b) of FIG. 8, the controller 180 partitions the messenger screen into a plurality of areas and then individually displays the chatting windows 21, 31 and 41 of the selected chatting counterparts 20, 30 and 40 on the partitioned areas, respectively.

In this case, the controller 180 is able to display first to third identifiers 22, 32 and 42 indicating that the selected chatting counterparts are the preferred chatting counterparts within the chatting windows 21, 31 and 41, respectively.

Since the chatting counterpart ‘LEE’ 50 is not the user-preferred chatting counterpart, the controller 180 is able to display a fourth identifier 52, which indicates that the chatting counterpart ‘LEE’ 50 is the chatting counterpart not preferred by the user, within the chatting window 51 of the ‘LEE’ 50.

The controller 180 is able to set the selected chatting counterparts 20, 30 and 40 to non-preferred chatting counterparts according to a user's manipulation of a menu 60. The controller 180 is able to set the non-preferred chatting counterpart ‘LEE’ 50 to a preferred chatting counterpart according to a user's manipulation of the menu 60.

Referring to (c) of FIG. 8, the controller 180 is able to display tab windows 21, 31 and 41 including chatting windows of the selected chatting counterparts 20, 30 and 40 and tabs relevant to the chatting windows on one screen of the messenger.

Meanwhile, referring to (b) or (c) of FIG. 8, in case of receiving a message containing a chatting content from the first chatting counterpart ‘TOM’ 20 among the selected chatting counterparts 20, 30 and 40 [S75], the controller 180 activates the first chatting window 21 of the first chatting counterpart 20 and deactivates the rest of the chatting windows 31, 41 and 51 except the first chatting window 21 of the first chatting counterpart 20 [S76].

In the present invention, ‘activation’ indicates that the chatting window 21, 31, 41 or 51 is in mode for enabling chatting with a current user. And. ‘deactivation’ indicates that the chatting window 21, 31, 41 or 51 is not in mode for enabling chatting with a current user.

Subsequently, the controller 180 displays the message received from the first chatting counterpart 20 on the activated chatting window 21 of the first chatting counterpart 20 [S77].

While the chatting window 21 of the first chatting counterpart 20 is activated, if a message is received from the second chatting counterpart (‘ALICE’) 30 [S78], the controller 180 deactivates the chatting window 21 of the first chatting counterpart 20 [S79], activates the chatting window 31 of the second chatting counterpart 30 [S80], and then displays the message received from the second chatting counterpart 30 on the activated chatting window 31 of the second chatting counterpart 30 [S81].

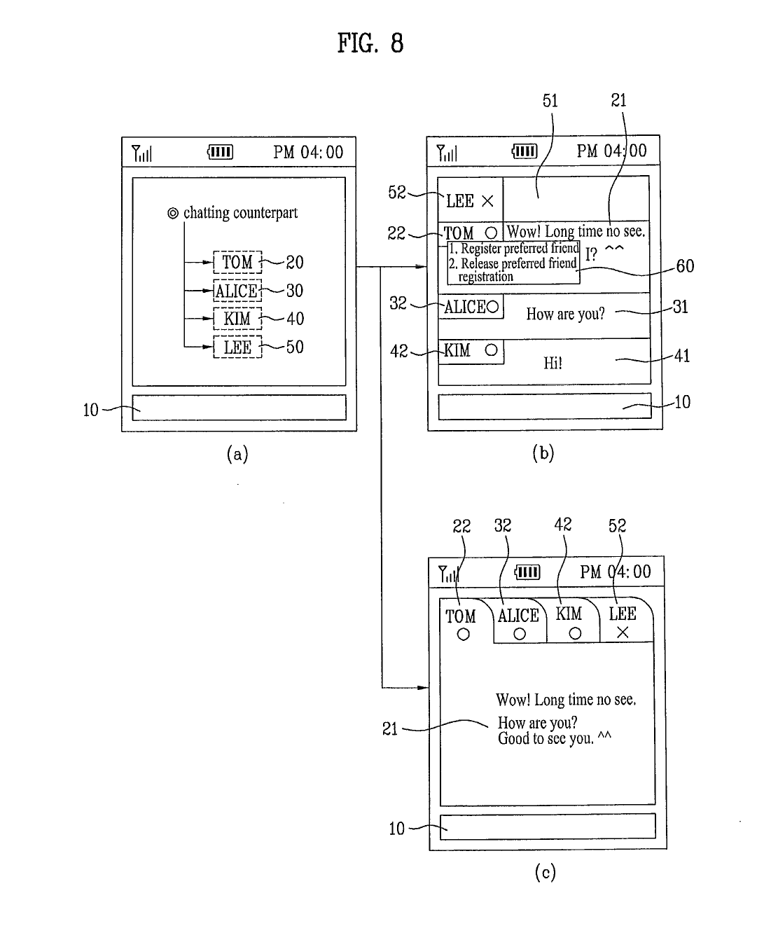

In the following description, a process for the controller 180 to switch the chatting windows is explained in detail with reference to FIGS. 9 to 15.

FIG. 9 is a diagram of screen configuration of a process for switching chatting windows of a plurality of chatting counterparts according to a first embodiment of the present invention.

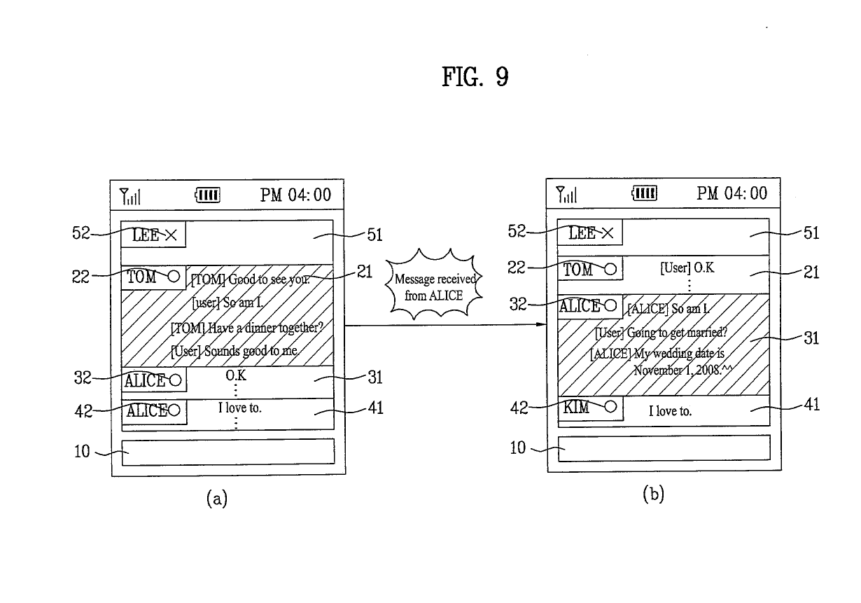

FIG. 10 is a diagram of screen configuration of a process for switching chatting windows of a plurality of chatting counterparts according to a second embodiment of the present invention.

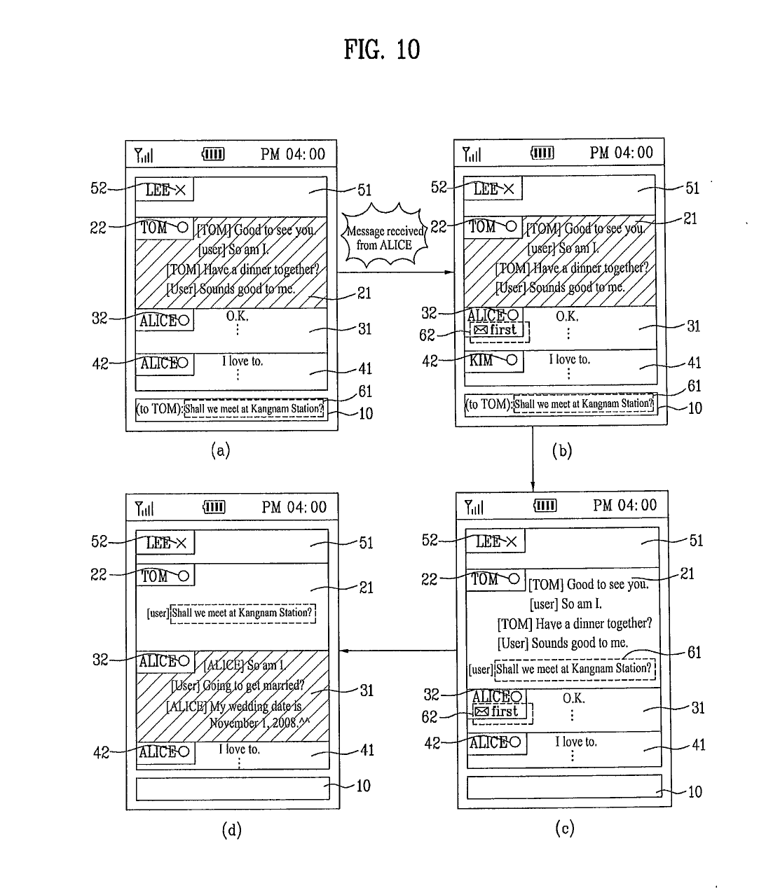

FIG. 11 is a diagram of screen configuration of a process for switching chatting windows of a plurality of chatting counterparts according to a third embodiment of the present invention.

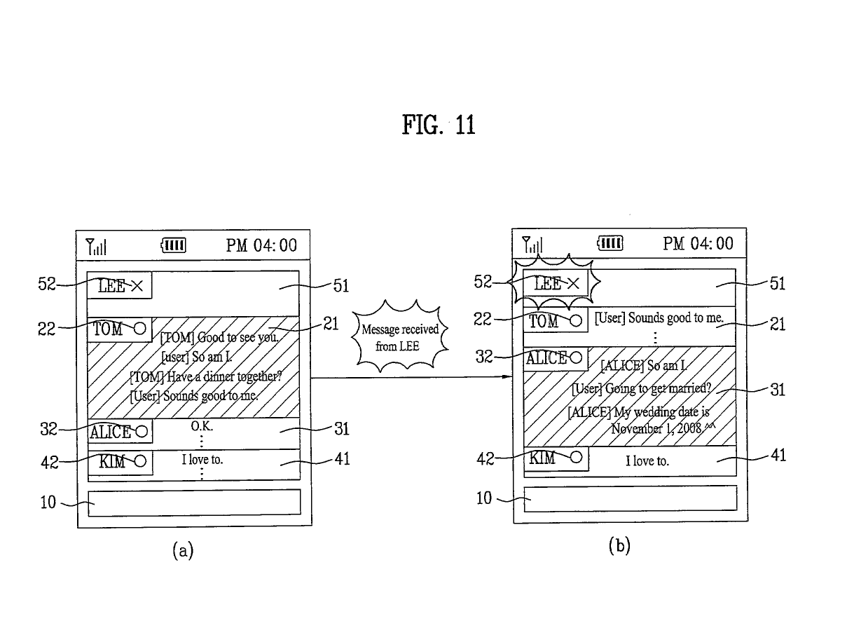

FIG. 12 is a diagram of screen configuration of a process for switching chatting windows of a plurality of chatting counterparts according to a fourth embodiment of the present invention.

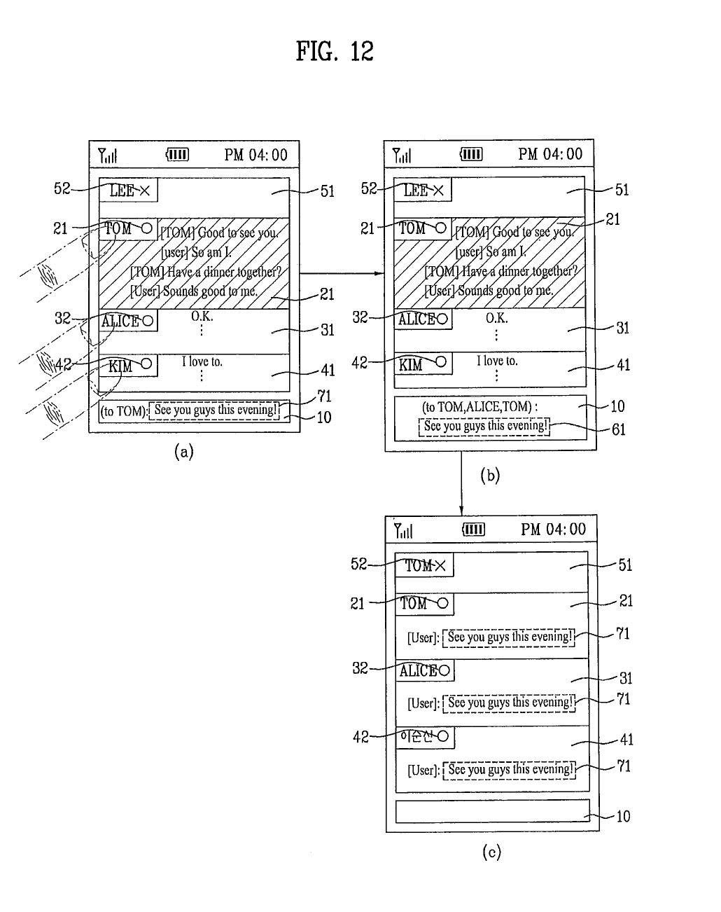

FIG. 13 is a diagram of screen configuration of a process for switching chatting windows of a plurality of chatting counterparts according to a fifth embodiment of the present invention.

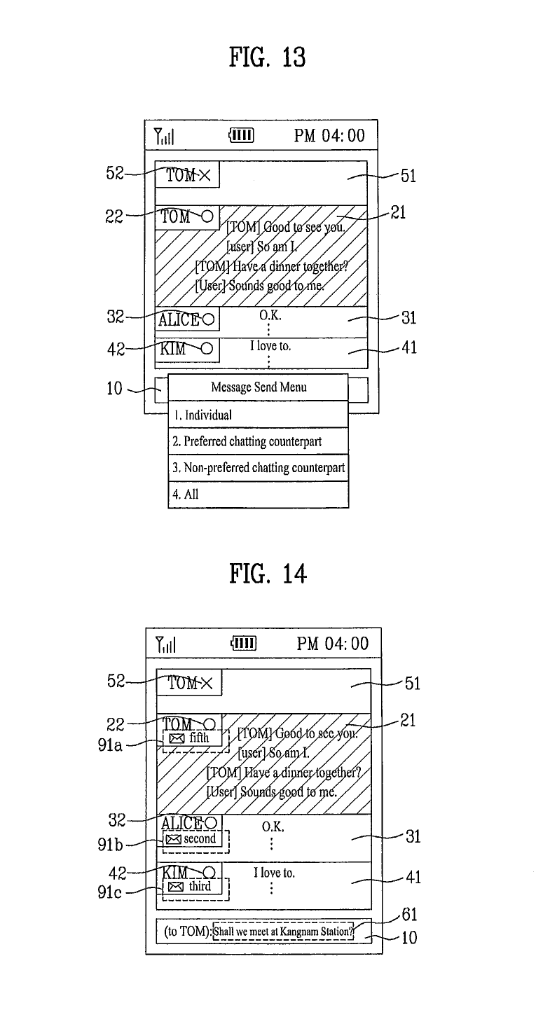

FIG. 14 is a diagram of screen configuration of a process for switching chatting windows of a plurality of chatting counterparts according to a sixth embodiment of the present invention.

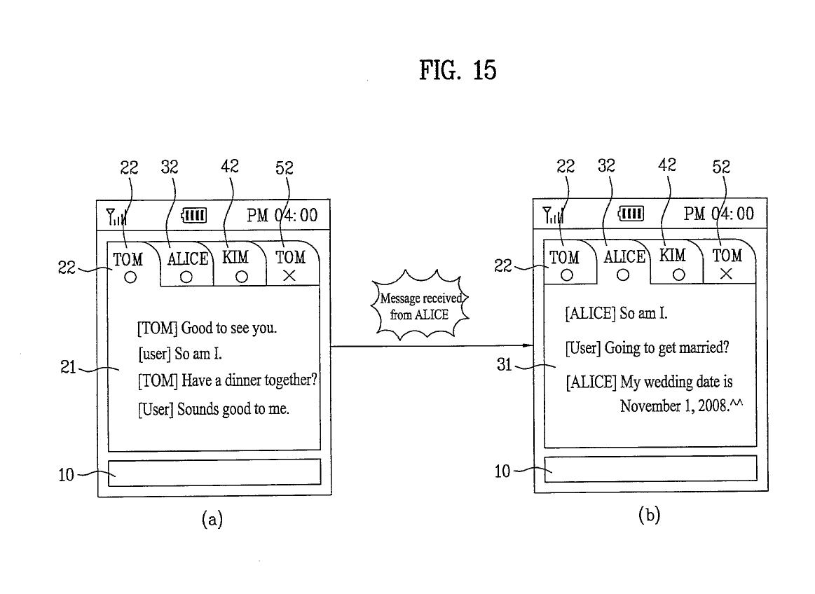

FIG. 15 is a diagram of screen configuration of a process for switching chatting windows of a plurality of chatting counterparts according to a seventh embodiment of the present invention.

Referring to (a) of FIG. 9, the controller 180 partitions the messenger screen, as shown in (b) of FIG. 8, into a plurality of areas and then individually displays the chatting windows 21, 31 and 41 of the selected chatting counterparts 20, 30 and 40 on the partitioned areas, respectively.

If a message including a chatting content is received from the first chatting counterpart (‘TOM’) 20 via the wireless communication unit 110, the controller 180 displays the received chatting content on the chatting window 21 by activating the first chatting window 21 of the first chatting counterpart 20, as shown in (a) of FIG. 9, and deactivates the rest of the chatting windows 31, 41 and 51 except the first chatting window 21 of the first chatting counterpart 20.

In doing so, the controller 180 is able to display the activated first chatting window 21 of the first chatting counterpart 20 to be discriminated from the deactivated chatting windows 31, 41 and 51 of the rest of the chatting counterparts 30, 40 and 50.

In particular, the controller 180 is able to display the activated first chatting window 21 and the deactivated chatting windows 31, 41 and 51, as shown in FIG. 9, in a manner of discriminating them by having the activated first chatting window 21 differ from the deactivated chatting windows 31, 41 and 51 in display size, display color, font format and/or the like.

Referring to (b) of FIG. 9, while the first chatting window 21 of the first chatting counterpart 20 is activated, if a message is received from the second chatting counterpart (‘ALICE’) 30, the controller 180 deactivates the first chatting window 21 of the first chatting counterpart 20 and then displays the received message on the second chatting window 31 by activating the second chatting window 31 of the second chatting counterpart 30.

In particular, after the first chatting window 21 has been activated, while a chatting content, which is to be sent to the first chatting counterpart 20, is not inputted for a predetermined duration by a user via a text input window 10, if a message is received from the second chatting counterpart (‘ALICE’) 30, it means that a current user is not performing the chatting with the first chatting counterpart 20. Hence, the controller 180 deactivates the first chatting window 21 and activates the second chatting window 31 of the second chatting counterpart 30.

On the contrary, while a user is inputting a chatting content 61, which is to be sent to the first chatting counterpart 20, via the text input window 10, as shown in (a) and (b) of FIG. 10, if a message is received from the second chatting counterpart 30, the controller does not activate the second chatting window 31 of the second chatting counterpart 30, as shown in (c) and (d) of FIG. 10, until the input of the chatting content 61 is completed.

In particular, as a message is received from the second chatting counterpart 30 while a user is having a chat with the first chatting counterpart 20, if the second chatting window 31 is activated, the chat with the first chatting counterpart 20 may be interrupted.

Therefore, the controller 180 activates the second chatting window 31 of the second chatting counterpart 30, as shown in (d) of FIG. 10, after the user finishes the chat with the first chatting counterpart 20 completely.

In doing so, the controller 180 is able to inform the user that the message has received from the second chatting counterpart 30 in a manner of displaying a fifth identifier 62 indicating the reception of the message and a reception count of the message, as shown in (b) and (c) of FIG. 10, on the second chatting window 31 of the second chatting counterpart 30 until the input of the chatting content 61 is completed.

Namely, while the user is having a chat with the first chatting counterpart 20, if at least one message is received from the second chatting counterpart 30, the controller 180 informs the user of the reception event and reception count of the at least one message of the second chatting counterpart 30. Therefore, the controller 180 enables the user to have a chat with the second chatting counterpart 20 by ending the chat with the first chatting counterpart 20.

In doing so, if the user selects the fifth identifier 62 using the user input unit 130 or the touchscreen 151, the controller 180 immediately deactivates the first chatting window 21 and activates the second chatting window 31.

If the input of the chatting content 61 is completed, as shown in (d) of FIG. 10, the controller 180 stops displaying the fifth identifier 62, deactivates the first chatting window 21, and activates the second chatting window 31.

Meanwhile, referring to (a) of FIG. 11, if a message is received from the non-preferred chatting counterpart (‘LEE’) 50, the controller 180 does not activate the fourth chatting window of the non-preferred chatting counterpart 50. Instead, referring to (b) of FIG. 11, the controller 180 is able to inform a user that the message is being received from the non-preferred chatting counterpart 50 in a manner of displaying the fourth identifier 52 of the non-preferred chatting counterpart 50 by discriminating it from the first to third identifiers 22, 32 and 42.

In doing so, the controller is able to have the fourth identifier 52 discriminated by differing from the first to third identifiers 22, 32 and 42 in display color, display size and/or font format. Optionally, the fourth identifier 52 can be discriminated from others in a manner of blinking.

Moreover, the controller 180 is able to inform a user that the message is being received from the non-preferred chatting counterpart 50 in a manner of displaying the fourth chatting window 51 of the non-preferred chatting counterpart 50 in a manner of discriminating the fourth chatting window 51 from the first to third chatting windows 21, 31 and 41.

Meanwhile, while the first chatting window 21 of the first chatting counterpart 20 is activated, as shown in (a) of FIG. 12, after a user has written a chatting content 71 via the text window 10, if the user selects chatting counterparts 30 and 40, to which the written chatting content will be sent, by manipulating the input unit 130 or the touchscreen 151, the controller 180, as shown in (b) and (c) of FIG. 12, sends a message containing the written chatting content 71 to the first chatting counterpart 20 and the selected chatting counterparts 30 and 40.

In particular, if there is a notification, which is to be sent to other preferred chatting counterparts 30 and 40 currently in deactivated mode as well as the first chatting counterpart 20 in the course of having a chat with the first chatting counterpart 20, the user is facilitated to deliver the notification to the whole preferred chatting counterparts 20, 30 and 40 by selecting the preferred chatting counterparts 30 and 40 after completion of writing the chatting content.

Alternatively, referring to FIG. 13, in the course of having a chat with the first chatting counterpart 20, a user is able to send a chatting content to other preferred chatting counterparts 30 and 40 or the non-preferred chatting counterpart 50 via a message send menu function 80.

In particular, using an individual send function 81 of the message send menu function, a user is able to individually send a chatting content written by himself. The user is able to send a chatting content written by himself to the whole preferred chatting counterparts 20, 30 and 40 using a preferred chatting counterpart send function 82.

A user is able to send a chatting content written by himself to the whole non-preferred chatting counterpart 50 via a non-preferred chatting counterpart send function 83. Moreover, a user is able to send a chatting content written by himself to all chatting counterparts currently registered to the messenger via a whole send function 84.

Referring to FIG. 14, the controller 180 obtains a message transceiving count between a user and each of the chatting counterparts 20, 30 and 40 and is then able to display sixth to eighth identifiers 91a, 91b and 91c indicating the message transceiving counts to the chatting windows 21, 31 and 41 of the chatting counterparts 20, 30 and 40, respectively.

In particular, the user is able to know that the user has a chat with which one of the chatting counterparts most frequently so far by checking the sixth to eighth identifiers 91a, 91b and 91c.

Meanwhile, referring to (a) of FIG. 15, the controller 180 is able to display tab windows 21, 31 and 41 including chatting windows of the selected chatting counterparts 20, 30 and 40 and tabs related to the chatting windows, as shown in (c) of FIG. 8, on a screen of the messenger.

If a message containing a chatting content is received from the first chatting counterpart (‘TOM’) 20 via the wireless communication unit 110, the controller 180 displays the received chatting content on the first tab window 21 by activating the first tab window 21, as shown in (a) of FIG. 15, and deactivates the rest of the tab windows 31, 41 and 51 except the first tab window 21 of the first chatting counterpart 20.

In doing so, the controller 180 is able to display the activated first tab window 21 of the first chatting counterpart 20 to be discriminated from the deactivated tab windows 31, 41 and 51 of the rest of the chatting counterparts 30, 40 and 50.

In particular, the controller 180 is able to display the activated first tab window 21 and the deactivated tab windows 31, 41 and 51, as shown in FIG. 9, in a manner of discriminating them by having the activated first tab window 21 differ from the deactivated tab windows 31, 41 and 51 in display size, display color, font format and/or the like.

Referring to (b) of FIG. 15, while the first tab window 21 of the first chatting counterpart 20 is activated, if a message is received from the second chatting counterpart (‘ALICE’) 30, the controller 180 deactivates the first tab window 21 of the first chatting counterpart 20 and then displays the received message on the second tab window 31 by activating the second tab window 31 of the second chatting counterpart 30.

In particular, after the first tab window 21 has been activated, while a chatting content, which is to be sent to the first chatting counterpart 20, is not inputted for a predetermined duration by a user via a text input window 10, if a message is received from the second chatting counterpart (‘ALICE’) 30, it means that a current user is not performing the chatting with the first chatting counterpart 20. Hence, the controller 180 deactivates the first tab window 21 and activates the second tab window 31 of the second chatting counterpart 30.

On the contrary, while a user is inputting a chatting content 61, which is to be sent to the first chatting counterpart 20, via the text input window 10, if a message is received from the second chatting counterpart 30, the controller may not activate the second tab window 31 of the second chatting counterpart 30, as shown in FIG. 10, until the input of the chatting content 61 is completed.

In doing so, the controller 180 is able to inform the user that the message has received from the second chatting counterpart 30 in a manner of displaying a fifth identifier 62 indicating the reception event of the message and a reception count of the message, as mentioned with reference to FIG. 10, on the second tab window 31 of the second chatting counterpart 30 until the input of the chatting content 61 is completed.

If the input of the chatting content 61 is completed, as shown in FIG. 10, the controller 180 stops displaying the fifth identifier 62, deactivates the first tab window 21, and activates the second tab window 31.

Meanwhile, as mentioned with reference to FIG. 11, if a message is received from the non-preferred chatting counterpart (‘LEE’) 50, the controller 180 does not activate the fourth tab window 51 of the non-preferred chatting counterpart 50. Instead, the controller 180 is able to inform a user that the message is being received from the non-preferred chatting counterpart 50 in a manner of displaying the fourth identifier 52 of the non-preferred chatting counterpart 50 by discriminating it from the first to third identifiers 22, 32 and 42.

Moreover, the controller 180 is able to inform a user that the message is being received from the non-preferred chatting counterpart 50 in a manner of displaying the fourth tab window 51 of the non-preferred chatting counterpart 50 in a manner of discriminating the fourth tab window 51 from the first to third tab windows 21, 31 and 41.

Meanwhile, while the first tab window 21 of the first chatting counterpart 20 is activated, as mentioned with reference to FIG. 12, after a user has written a chatting content 71 via the text window 10, if the user selects chatting counterparts 30 and 40, to which the written chatting content will be sent, by manipulating the input unit 130 or the touchscreen 151, the controller 180 sends a message containing the written chatting content 71 to the first chatting counterpart 20 and the selected chatting counterparts 30 and 40.

As mentioned with reference to FIG. 13, in the course of having a chat with the first chatting counterpart 20, a user is able to send a chatting content to other preferred chatting counterparts 30 and 40 or the non-preferred chatting counterpart 50 via a message send menu function 80.

In particular, using an individual send function 81 of the message send menu function, a user is able to individually send a chatting content written by himself. The user is able to send a chatting content written by himself to the whole preferred chatting counterparts 20, 30 and 40 using a preferred chatting counterpart send function 82. A user is able to send a chatting content written by himself to the whole non-preferred chatting counterpart 50 via a non-preferred chatting counterpart send function 83. Moreover, a user is able to send a chatting content written by himself to all chatting counterparts currently registered to the messenger via a whole send function 84.

As mentioned with reference to FIG. 14, the controller 180 obtains a message transceiving count between a user and each of the chatting counterparts 20, 30 and 40 and is then able to display sixth to eighth identifiers 91a, 91b and 91c indicating the message transceiving counts to the tab windows 21, 31 and 41 of the chatting counterparts 20, 30 and 40, respectively.

In particular, the user is able to know that the user has a chat with which one of the chatting counterparts most frequently so far by checking the sixth to eighth identifiers 91a, 91b and 91c.

According to the present invention, the above-described methods can be implemented in a program recorded medium as computer-readable codes. The computer-readable media include all kinds of recording devices in which data readable by a computer system are stored. The computer-readable media include ROM, RAM, CD-ROM, magnetic tapes, floppy discs, optical data storage devices, and the like for example and also include carrier-wave type implementations (e.g., transmission via Internet). And, the computer can include the controller 180 of the terminal.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mobile communication terminal, comprising:
a display module configured to display a messenger for performing chatting with one or more chatting counterparts;
a wireless communication unit configured to transmit a user-written message to at least one of the one or more chatting counterparts, the wireless communication unit further configured to receive one or more messages from the at least one of the one or more chatting counterparts; and
a controller operatively connected to the display module and the wireless communication unit, the controller configured to display individual chatting windows corresponding to the one or more chatting counterparts on a screen of the messenger,
wherein if a first message is received from a first of the one or more chatting counterparts, the controller is configured to activate a first chatting window and display the received first message in the first chatting window.

2. The mobile communication terminal of claim 1,
wherein the controller is configured to partition the screen into one or more regions, and
wherein the controller is configured to display the one or more chatting windows on respective ones of the one or more regions.

3. The mobile communication terminal of claim 1, wherein the controller is configured to display one or more tab windows on the screen, each of the tab windows including at least one of the one or more chatting windows and one or more corresponding tables.

4. The mobile communication terminal of claim 3, wherein the controller is configured to deactivate the one or more tab windows except for a tab window corresponding to the first chatting counterpart.

5. The mobile communication terminal of claim 1, wherein the controller is configured to display the one or more chatting windows in a manner that discriminates between activated chatting windows and deactivated chatting windows.

6. The mobile communication terminal of claim 1, wherein the controller is configured to activate a second chatting window corresponding to a second chatting counterpart only if a second message is received from the second chatting counterpart while a chatting content is not inputted by a user of the mobile communication terminal.

7. The mobile communication terminal of claim 1, wherein if a second message is received from a second chatting counterpart while a chatting content is being inputted by a user of the mobile communication terminal, the controller is configured to activate a second chatting window corresponding to the second chatting counterpart only after completion of an input of the chatting content by the user.

8. The mobile communication terminal of claim 1,
wherein, if a second message is received from a second chatting counterpart while a chatting content is being inputted by a user of the mobile communication terminal, the controller is configured to display, before completion of an input of the chatting content, information indicating a message reception event and a message reception count on a second chatting window corresponding to the second chatting counterpart, and
wherein, when the input of the chatting content is completed, the controller is configured to activate the second chatting window.

9. The mobile communication terminal of claim 1,
wherein the controller is configured to maintain a message transceiving count of each of the one or more chatting counterparts, and
wherein the controller is configured to display corresponding message transceiving count information on respective ones of the one or more chatting windows.

10. The mobile communication terminal of claim 1, wherein if at least one of the one or more chatting counterparts is selected by a user of the mobile communication terminal, upon completion of an input of a chatting content in a chatting window of the at least one selected counterpart, the controller is configured to send a message including the inputted chatting content to the at least one selected chatting counterpart.

11. A method of controlling a mobile communication terminal, comprising the steps of:
displaying a messenger for performing chatting with one or more chatting counterparts and displaying chatting windows with the chatting counterparts on a screen of the messenger individually;
if a message is received from a first of the one or more chatting counterparts, activating a corresponding first chatting window for chatting with the first chatting counterpart; and
displaying the received message on the activated first chatting window.

12. The method of claim 11, the step of displaying chatting windows comprising the steps of:
partitioning the messenger screen into one or more regions; and
displaying the one or more chatting windows on respective ones of the one or more regions.

13. The method of claim 11, the step of displaying chatting windows comprising the step of:
displaying one or more tab windows, each of the tab windows including at least one of the one or more chatting windows and one or more corresponding tables.

14. The method of claim 13, further comprising the step of:
deactivating the one or more tab windows except for a tab window corresponding to the first chatting counterpart.

15. The method of claim 11, further comprising the step of:
displaying the one or more chatting windows in a manner that discriminates between activated chatting windows and deactivated chatting windows.

16. The method of claim 11, further comprising the step of:
activating a second chatting window corresponding to a second chatting counterpart only if a second message is received from the second chatting counterpart while a chatting content is not inputted by a user of the mobile communication terminal.

17. The method of claim 11, further comprising the step of:
if a second message is received from a second chatting counterpart while a chatting content is being inputted by a user of the mobile communication terminal, activating a second chatting window corresponding to the second chatting counterpart only after completion of an input of the chatting content by the user.

18. The method of claim 11, further comprising the steps of:
if a second message is received from a second chatting counterpart while a chatting content is being inputted by a user of the mobile communication terminal, displaying, before completion of an input of the chatting content, information indicating a message reception event and a message reception count on a second chatting window corresponding to the second chatting counterpart, and
when the input of the chatting content is completed, activating the second chatting window.

19. The method of claim 11, further comprising the steps of:
maintaining a message transceiving count of each of the one or more chatting counterparts; and
displaying corresponding message transceiving count information on respective ones of the one or more chatting windows.

20. The method of claim 11, further comprising the step of:
if at least one of the one or more chatting counterparts is selected by a user of the mobile communication terminal, upon completion of an input of a chatting content in a chatting window of the at least one selected counterpart, sending a message including the inputted chatting content to the at least one selected chatting counterpart.
